(19) United States
(12) Patent Application Publication
(10) Pub. No.: US 2007/0016875 A1
(43) Pub. Date: Jan. 18, 2007

(54) Method and system for partial sizing adjacency constraint in a multi-pane window frame

(75) Inventor: Lucinio Santos-Gomez, Durham, NC (US)

Correspondence Address: DUKE W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 11/179,710

(22) Filed: Jul. 12, 2005

(51) Int. Cl. G06F 3/00; G06F 17/00

(52) U.S. Cl. 715/798; 715/781

(57) ABSTRACT

A system for managing panes in a multi-pane window frame. A multi-pane window frame application program displays the multi-pane window frame in a graphical user interface. Subsequent to displaying the multi-pane window frame, the multi-pane window frame application program receives a user pane configuration input and identifies a sizing constraint setting, wherein the sizing constraint setting establishes adjacent pane interaction within the multi-pane window frame. After receiving the user pane configuration input and identifying the sizing constraint setting, the multi-pane window frame application program resizes a pane contained within the multi-pane window frame based on the user pane configuration input and the sizing constraint setting.

### BACKGROUND OF THE INVENTION

1. Field of the Invention

The present invention relates to an improved data processing system. More specifically, the present invention is directed to a method, apparatus, and computer usable code for partial sizing adjacency constraint in a multi-pane window frame.

2. Description of the Related Art

Currently, a popular way to present information to computer system users is via a graphical user interface (GUI). A GUI is usually a component of a computer environment, which is provided by an operating system. However, an application program also may create a GUI by independently displaying objects on a screen for utilities provided by the operating system. In addition, a combination of the operating system and application program approaches also may be used to create a GUI.

A GUI permits an end user to interact with a computer through the more intuitive operations of “point and click” on graphical display elements with a pointer controlled by a mouse or other user interface device. A mouse is typically employed by a user of a computer to interact with the computer's GUI. A “pointer” is an iconic image controlled by a mouse and is displayed on the computer's GUI for the user to visually select or manipulate icons, menus, and other types of graphical objects.

Information is often presented to an end user in a GUI environment using a graphical user interface component known as a window. A window is a scrollable viewing area on a GUI and is generally rectangular in shape. A window is the central way to provide information to, and receive information from, a user. Usually one or more active windows are present on the display screen at any given time. Each window conveys information about an application program or other process executing in the computer. Multiple windows may be present for a single application program where each window is used to convey different types of information. Also, multiple views of the same information, such as two text windows showing overlapping portions of the same document, may be present. Typically, the computer system displays information within the window and accepts information from the user, sometimes in the form of a special window called a dialog box. The user often has some control over the existence, placement and size of a window and sometimes may even control the amount and type of information conveyed by the window.

Windows may be manipulated both by the computer and by the human user. Usually, the user may resize windows so that the window's height and width may be adjusted. Windows may be moved around on the screen so that the windows may be repositioned virtually anywhere and may be overlapped by positioning a portion of one window over another.

In rich application program software, related subsets of objects and information in multiple sizeable windows or panes may be possible. A pane is usually a rectangular area within an on-screen window that contains information for the user. A window may have multiple panes. These rich application programs often require that the user work with the windows and panes simultaneously.

Two standard window design models are currently used to manage size and allocation in interdependent windows and panes in an application program. First is a multiple-document interface (MDI) model. Multiple-document interface is a window function that allows an application to display, and let a user work with, more than one document at the same time. The multiple documents comprising an application program are confined to a window frame, but may be moved freely inside the window frame. A feature of the multiple-document interface model is full flexibility to size each document within the window frame independently of the size of the other documents contained within the window frame, which may result in document overlap. The overlap of documents or windows is known as a cascade arrangement.

The second standard window design model is a multiple-pane window interface model. In the multiple-pane window interface model, panes are allocated adjacently so that the pane's sizing and layout is constrained by the pane's interdependent positioning. In other words, the sizing of one pane affects the size and layout of adjacent panes. This constraint on adjacent panes is termed adjacency constraints. Adjacency constraints are established between panes in a window frame to preserve a tile arrangement in a virtual two-dimensional space, which in turn preserves border sharing between the adjacent panes. The tile arrangement displays objects side by side, or in a row and column order, in a graphical user interface.

A benefit of the multiple-pane window interface model is that space in the window frame is optimized, which means no underutilized or dead areas are found in the window frame. In addition, due to the full adjacency constraints in the multiple-pane window interface model, management of the panes is easier for the user.

### BRIEF SUMMARY OF THE INVENTION

Embodiments of the present invention provide a method, apparatus, and computer usable code for managing panes in a multi-pane window frame. A multi-pane window frame application program displays the multi-pane window frame in a graphical user interface. Subsequent to displaying the multi-pane window frame, the multi-pane window frame application program receives a user pane configuration input and identifies a sizing constraint setting, wherein the sizing constraint setting establishes adjacent pane interaction within the multi-pane window frame. After receiving the user pane configuration input and identifying the sizing constraint setting, the multi-pane window frame application program resizes a pane contained within the multi-pane window frame based on the user pane configuration input and the sizing constraint setting.

### BRIEF DESCRIPTION OF THE SEVERAL VIEWS OF THE DRAWINGS

The novel features believed characteristic of the invention are set forth in the appended claims. The invention itself, however, as well as a preferred mode of use, will best be understood by reference to the following detailed description of an illustrative embodiment when read in conjunction with the accompanying drawings, wherein:

FIG. 1 is a pictorial representation of a data processing system in which the aspects of the present invention may be implemented;

FIG. 2 is a block diagram of a data processing system in which aspects of the present invention may be implemented;

FIG. 3 is a block diagram of a data processing system in accordance with an embodiment of the present invention;

FIG. 4 is an exemplary illustration of a graphical user interface displaying a known multiple-document interface model with no adjacency constraint;

FIG. 5 is an exemplary illustration of a graphical user interface displaying a known multi-pane window model with full adjacency constraint;

FIGS. 6A-6I are exemplary illustrations of varying pane configurations within a multi-pane window frame using partial and full sizing adjacency constraints in accordance with illustrative embodiments of the present invention; and

FIG. 7 is a flowchart illustrating an exemplary process for resizing panes in partial and full adjacency constraints in a multi-pane window frame in accordance with an illustrative embodiment of the present invention.

### DETAILED DESCRIPTION OF THE INVENTION

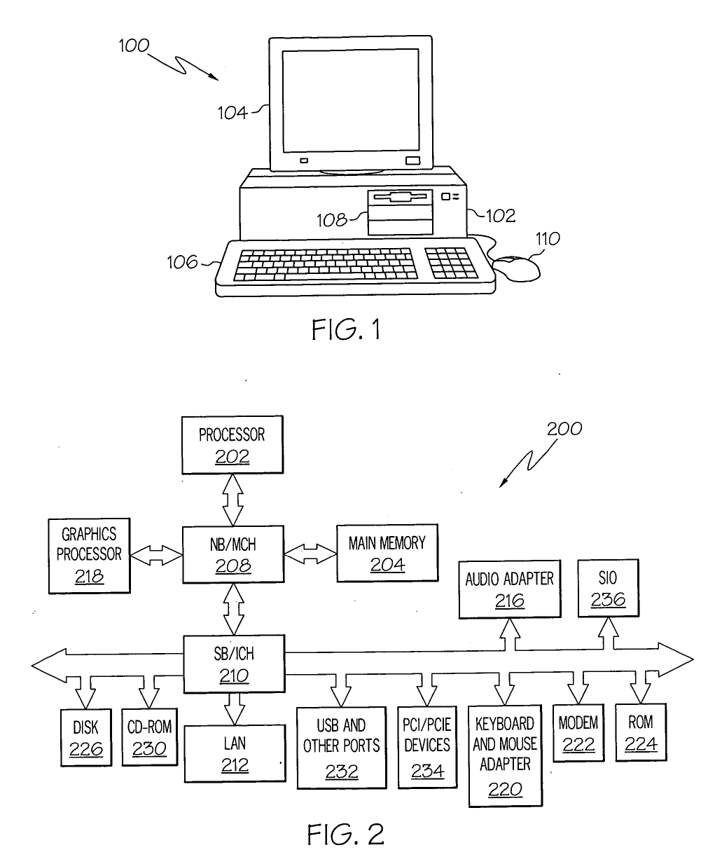

With reference now to the figures and in particular with reference to FIG. 1, a pictorial representation of a data processing system is depicted in which the aspects of the present invention may be implemented. Computer 100 is shown that includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM® eServer™ computer or IntelliStation® computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is depicted in which aspects of the present invention may be implemented. Data processing system 200 is an example of a computer, such as computer 100 in FIG. 1, in which code or instructions implementing the processes of the present invention may be located. In the depicted example, data processing system 200 employs a hub architecture including a north bridge and memory controller hub (MCH) 208 and a south bridge and input/output (I/O) controller hub (ICH) 210. Processor 202, main memory 204, and graphics processor 218 are connected to MCH 208. Graphics processor 218 may be connected to the MCH through an accelerated graphics port (AGP), for example.

In the depicted example, local area network (LAN) adapter 212, audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to ICH 210. PCI/PCIe devices may include, for example, Ethernet adapters, add-in cards, PC cards for notebook computers, etc. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. Super I/O (SIO) device 236 may be connected to ICH 210.

An operating system runs on processor 202 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200 (Java is a trademark of Sun Microsystems, Inc. in the United States, other countries, or both).

Instructions for the operating system, the object-oriented programming system, and applications or programs are located on storage devices, such as hard disk drive 226, and may be loaded into main memory 204 for execution by processor 202. The processes of embodiments of the present invention are performed by processor 202 using computer implemented instructions, which may be located in a memory such as, for example, main memory 204, read only memory 224, or in one or more peripheral devices.

Those of ordinary skill in the art will appreciate that the hardware in FIG. 1 and FIG. 2 may vary depending on the implementation. Other internal hardware or peripheral devices, such as flash memory, equivalent non-volatile memory, or optical disk drives and the like, may be used in addition to or in place of the hardware depicted in FIG. 1 and FIG. 2. Also, the processes of embodiments of the present invention may be applied to a multiprocessor data processing system.

As some illustrative examples, data processing system 200 may be a personal digital assistant (PDA), which is configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 204 or a cache such as found in MCH 208. A processing unit may include one or more processors or CPUs. The depicted examples in FIG. 1 and FIG. 2 and above-described examples are not meant to imply architectural limitations. For example, data processing system 200 also may be a tablet computer, laptop computer, or telephone device in addition to taking the form of a PDA.

An embodiment of the present invention provides an improved method, apparatus, and computer implemented instructions for managing panes in a multi-pane window frame. A multi-pane window frame application program displays the multi-pane window frame in a graphical user interface. Subsequent to displaying the multi-pane window frame, the multi-pane window frame application program receives a user pane configuration input and identifies a sizing constraint setting, wherein the sizing constraint setting establishes adjacent pane interaction within the multi-pane window frame.

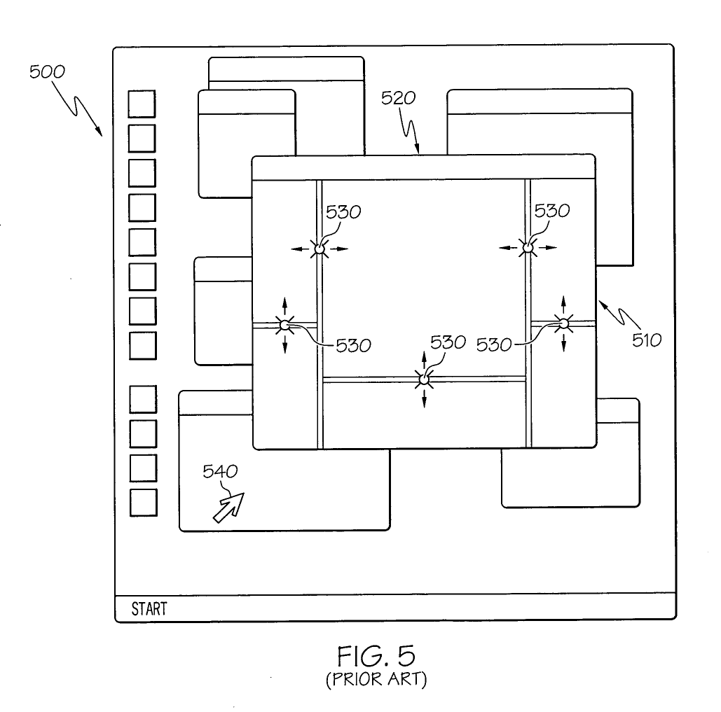

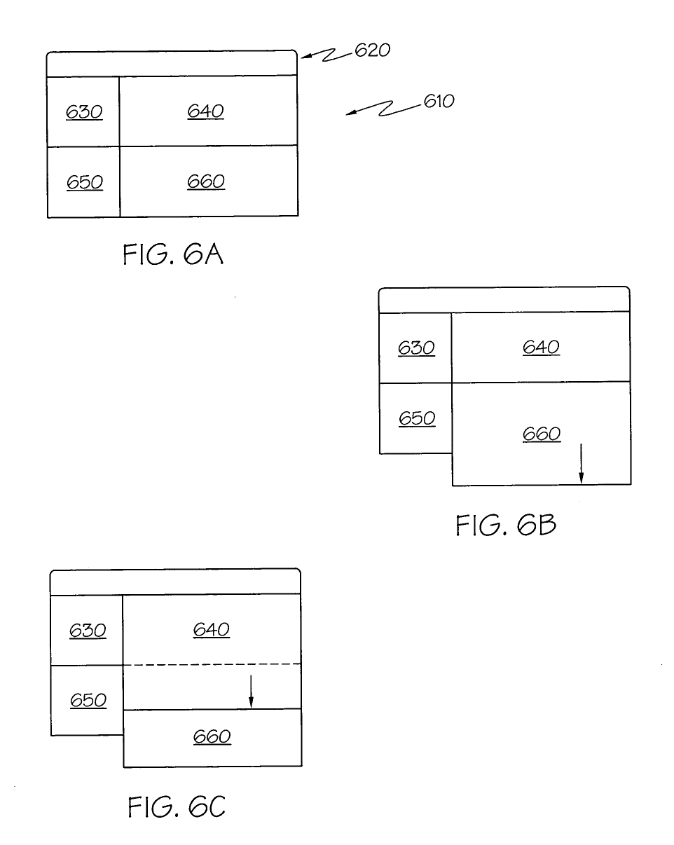

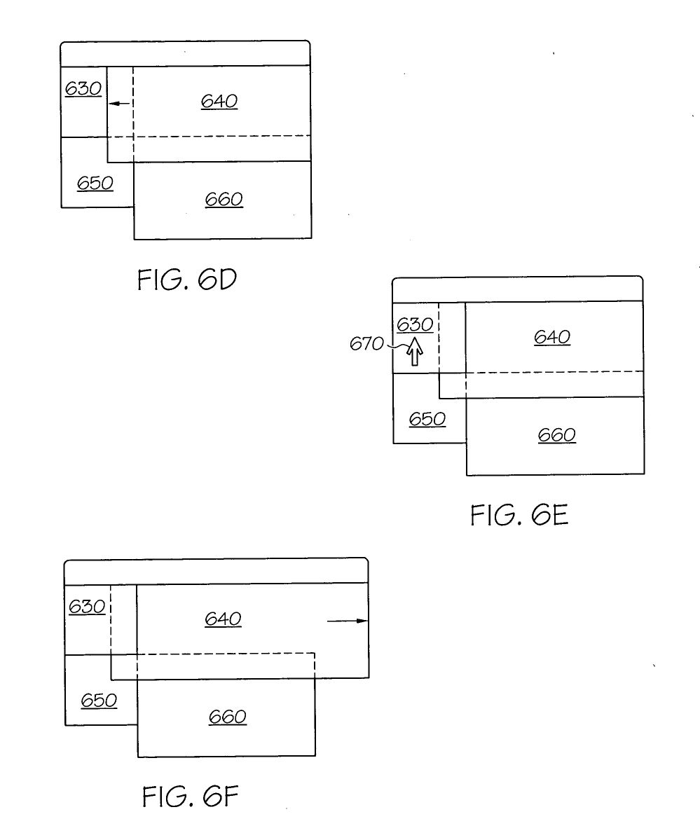

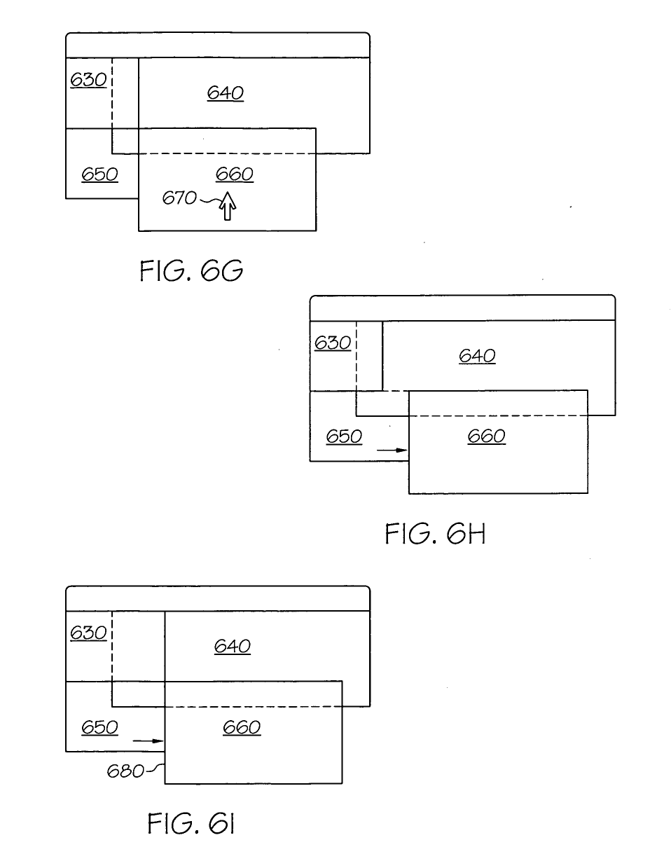

A user pane configuration input is the manipulation of a pane size handler by a user, for the purpose of resizing a pane to the user's desired pane configuration, using a pointing device in a graphical user interface. For example, a user pane configuration input is when a user uses a pointing device, such as mouse 110 in FIG. 1, to manipulate pane size handlers contained within pane borders, such as pane size handlers 530 in FIG. 5, in order to resize the individual panes according to the user's desired pane configuration. By manipulating the pane size handlers, the user may move horizontal or upper and lower pane borders vertically or up and down, while vertical or side pane borders may be moved horizontally or side to side, as shown in FIG. 5 and demonstrated in FIGS. 6A-6I.

A sizing constraint setting in these examples is either a default partial adjacency constraint setting or an optional full adjacency constraint setting. The sizing adjacency constraint setting determines adjacent pane interaction when a pane is resized by a user. Adjacent pane interaction is how panes react to an adjacent pane's resizing. For example, when a pane is resized by a user in the optional full adjacency constraint setting, panes adjacent to the user resized pane are themselves resized automatically within the multi-pane window frame to the same extent and in the opposite direction as the user resized pane. Thus, pane interaction between adjacent panes during pane resizing occurs in the full adjacency constraint setting. FIG. 6I illustrates pane resizing using the full adjacency constraint setting.

However, when a pane is resized by a user in the default partial adjacency constraint setting, panes adjacent to the user resized pane are not themselves resized. As a result, in the partial adjacency constraint setting, no pane interaction results during pane resizing. Alternatively, pane interaction may result during pane resizing in the partial adjacency constraint setting if, for example, predetermined sizing behavior policies allow such behavior. Sizing behavior policies are discussed in the description of FIG. 6A below. FIGS. 6A-6H demonstrate pane resizing utilizing the partial adjacency constraint setting.

After receiving the user pane configuration input and identifying the sizing constraint setting, the multi-pane window frame application program resizes a pane contained within the multi-pane window frame based on the user pane configuration input and the sizing constraint setting.

A feature of embodiments of the present invention is that all panes may be independently resized within a multi-pane window frame. Benefits of different embodiments of the present invention utilizing partial adjacency constraint may be that more flexibility in resizing individual panes is realized as compared to systems using full adjacency constraint and easier management of individual panes is realized as compared to systems using a multiple-document interface model. In addition, embodiments of the present invention combine the benefits of both the multiple-document interface mode and the multiple-pane window interface mode. Another feature of embodiments of the present invention is that a user may switch between full or partial adjacency constraints for resizing panes while using a multi-pane window application program.

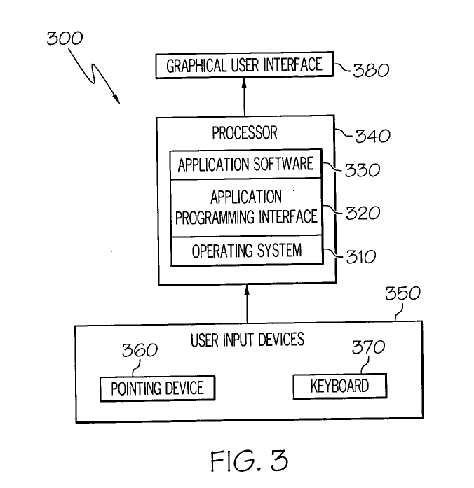

Referring now to FIG. 3, a block diagram of a data processing system in accordance with an embodiment of the present invention is shown. Data processing system 300 may be, for example, data processing system 200 in FIG. 2. Operating system 310, application programming interface 320, and application software 330 may reside, for example, in processor 340.

Operating system 310 is utilized to provide high-level functionality to the user and to other software. Such an operating system typically includes a basic input output system (BIOS). Application programming interface (API) 320 allows a user of data processing system 300, an individual, or a software routine, to invoke system capabilities using a standard consistent interface without concern for how the particular functionality is implemented. Application software 330 may run, for example, on operating system 310. Application software 330 represents any number of software applications designed to react to data to provide the desired functionality the user seeks. The software applications represented by application software 330 may include those software applications necessary to handle data, video, graphics, photos, or text. Embodiments of the present invention may be implemented within application software 330 in these examples.

Processor 340, such as, for example, processor 202 in FIG. 2, performs the basic operations in data processing system 300. Processor 340 may, for example, display information on graphical user interface (GUI) 380. GUI 380 has a plurality of picture elements, collectively referred to as a screen, which may define the appearance of a user interface environment displayed on GUI 380. GUI 380 screen contents and, therefore, the appearance of the user interface environment, may be controlled or altered by application software 330 or operating system 310 either individually or in combination.

Operating system 310, application software 330, or both, may employ user input devices 350 in order to obtain input from a user. User input devices 350 may include pointing device 360 and keyboard 370, such as, for example, mouse 110 and keyboard 106 in FIG. 1, or any other input device known to those of skill in the art. User input devices 350 may be used, for example, to manipulate a window frame or panes contained within a multi-pane window system displayed on GUI 380. However, embodiments of the present invention are not restricted to utilizing user input devices 350 for the sole purpose of manipulating window frames and panes. User input devices 350 may be used for any purpose necessary to accomplish the processes for different embodiments of the present invention.

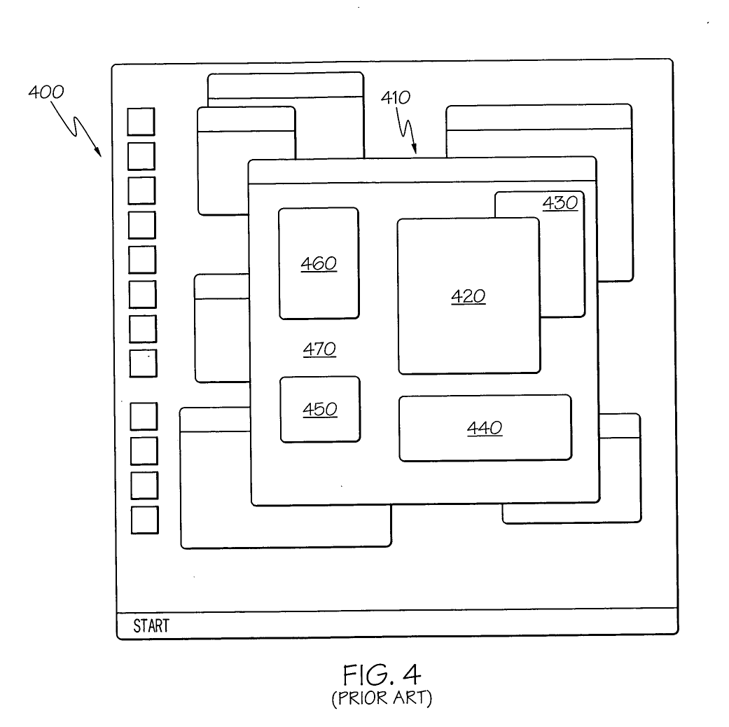

Turning now to FIG. 4, an exemplary illustration of a graphical user interface is depicted displaying a known multiple-document interface (MDI) model with no adjacency constraint. GUI 400, such as, for example, graphical user interface 380 in FIG. 3, displays multiple-document interface window frame 410. Multiple-document interface window frame 410 contains documents 420-460 and dead area 470. As is shown in FIG. 4, documents 420-460 are disjointed in that documents 420-460 are not physically connected in a relational manner. Documents 420-460 may be freely moved within multiple document interface window frame 410. In other words, no adjacency constraint exists, which allows full flexibility of document sizing and movement within multiple document interface window frame 410. However, documents 420-460 must be resized and/or moved individually to optimize the display of desired documents within multiple-document interface window frame 410, which may be user time intensive. In addition, multiple-document interface window frame 410 may contain dead area 470. Dead area 470 is a result of the area contained within multiple-document interface window frame 410 not being optimally used. In other words, dead area 470 is unused space within multiple-document interface window frame 410. Further, multiple-document interface model 410 allows one document, such as document 420, to overlay and obscure the contents of another document, such as document 430.

With reference now to FIG. 5, an exemplary illustration of a graphical user interface displaying a known multiple-pane window model with full adjacency constraint is shown. GUI 500, such as, for example, graphical user interface 380 in FIG. 3, displays multi-pane window 510 and pointer icon 540. Multi-pane window 510 contains title bar 520, pane size handlers 530, and six panes shown in full adjacency constraint with no dead area, such as, for example, dead area 470 in FIG. 4. Pane size handlers 530 may be used to resize the panes contained within multi-pane window 510. However, in full adjacency constraint, individual panes contained within multi-pane window 510 may not be resized without affecting adjacent panes. In other words, as one pane is resized in multi-pane window 510 using pane size handlers 530, the adjacent pane or panes are resized to the same extent in an opposite manner.

Consequently, space in multi-pane window 510 is optimized, but freedom to resize individual panes is reduced in full adjacency constraint. Even though a user does not have to resize each pane individually using this multiple-pane window system with full adjacency constraint, which affords easier pane management, what may be an optimal pane size for one pane may not be an optimal pane size for an adjacent pane. Also, it should be noted that embodiments of the present invention may utilize more or fewer pane size handlers than are shown in the example of FIG. 5 to accomplish the processes of the present invention.

A user may use pointer icon 540 to, for example, resize the panes in multi-pane window 510. The user may manipulate pointer icon 540 by, for example, using a pointing device, such as mouse 110 in FIG. 1. The user manipulates the mouse to position pointer icon 540 over desired pane size handlers 530, clicks and holds the mouse click while pointer icon 540 is over the desired pane size handlers 530, moves pointer icon 540 to the desired resizing pane position, and then releases the mouse click to complete the pane resizing.

Referring now to FIGS. 6A-6I, exemplary illustrations of varying pane configurations within a multi-pane window frame using partial and full sizing adjacency constraints is depicted in accordance with illustrative embodiments of the present invention. Multi-pane window frame 610 may be, for example, multi-pane window frame 510 contained within GUI 500 in FIG. 5. FIGS. 6A-6I show multi-pane window frame 610 in varying pane configurations and are for illustrations purposes only. Embodiments of the present invention are not restricted to the pane configurations depicted in FIGS. 6A-6I. Any and all possible pane configurations made by embodiments of the present invention are intended.

FIG. 6A depicts a default multi-pane window frame configuration after a user opens a multi-pane window frame software application and the multi-pane window frame software application displays the default multi-pane window frame configuration in a GUI. For example, a user opens application software 330 and application software 330 displays the software application in GUI 380 in FIG. 3. Of course, any default multi-pane window frame configuration may be utilized by embodiments of the present invention.

Multi-pane window frame 610 contains title bar 620, such as, for example, title bar 520 in FIG. 5. It should be noted that multi-pane window frame 610 contains only one title bar, title bar 620. Title bar 620 may contain, for example, a title for the multi-pane window frame application program, a minimize icon, a maximize icon, and a close icon. Also, it should be noted that no pane contained within multi-pane window frame 610 has a title bar. Further, a user may move multi-pane window frame 610, which includes a plurality of panes, in unison by, for example, clicking on and dragging title bar 620 using a mouse.

Multi-pane window frame 610 also contains panes 630, 640, 650, and 660. However, embodiments of the present invention may contain more or fewer panes. Also, FIG. 6A illustrates panes 630-660 in different sizes, but it should be noted that panes 630-660 may all be the same size in the default configuration when the multi-pane window frame software application displays the multi-pane window frame in a GUI.

After a GUI displays the default configuration of panes 630-660, a user may resize any of panes 630-660 as desired. However, predetermined sizing behavior policies may be implemented to govern pane resizing. Sizing behavior policies may include, for example: (1) when a pane is resized, an adjacent pane is effected only to the extent the resized pane is moved; (2) the upper border of a pane adjacent to the window frame's title bar may not be moved upward; (3) moving a vertical border, which is also a border of the window frame, resizes the window frame's title bar in the same direction and to the same extent the vertical border is moved; and (4) the “top” pane may partially overlap or obstruct other panes “underneath” and is determined by the sequence of user sizing gestures. Of course, embodiments of the present invention are not restricted to the above listed sizing behavior policies. Any sizing behavior policy necessary to employ the processes of embodiments of the present invention is intended.

FIG. 6B shows a user resizing pane 660, in a default partial adjacency constraint setting, by moving the lower border of pane 660 in a downward direction by using, for example, pane size handlers, such as pane size handlers 530 in FIG. 5. It should be noted that all pane resizing in illustrated examples 6B-6I may be accomplished by utilizing pane size handlers. Further, it should be noted that all pane resizing in FIGS. 6B-6H is accomplished by partial adjacency constraint.

In partial adjacency constraint, the lower border of pane 650 does not move when a user moves the lower border of pane 660 downward. Resizing a pane in partial adjacency constraint will not create a subsequent resizing of an adjacent pane. In other words, panes not currently being resized by a user in a window frame will remain the same size, as will be evident in the illustration of FIG. 6C. However, partial adjacency constraint is a limited constraint system in that a minimum overlap or adjacency to at least one other pane in the window frame is required.

In other words, resizing of any pane within the window frame may not result in pane isolation, either for the pane being resized or for any other pane affected by the pane resizing. Isolation means that the resized pane has neither adjacency, a shared border, nor area overlap with at least one other pane in the window frame. This limited partial constraint system ensures that a resized pane, or any pane affected by the pane resizing, remains as part of the multi-pane window frame. Additionally, this limited partial constraint system ensures that all panes remain a part of the window frame during movement of the entire window frame within a GUI.

FIG. 6C depicts a user resizing pane 640 by moving the lower border downward. Consequently, the size of pane 640 is increased. However, the size of pane 660 is unchanged, as indicated by the dotted line. The area between the dotted line and the lower border of pane 640 represents layering or overlapping of panes 640 and 660. Pane 640 is fully visible and on “top” of pane 660, while pane 660 is partially obstructed and “underneath” pane 640. It should be noted that in subsequent illustrations, a pane that includes a dotted line indicates that the pane with the dotted line is underneath a pane with a solid lines.

FIG. 6D again shows a user resizing pane 640, but in this example the user is moving the left border of pane 640 in a left lateral direction. Panes 630, 650, and 660 remain unchanged in size as a result of resizing pane 640. However, panes 630 and 650 are now partially obscured as indicated by the dotted lines. Pane 660 continues to be partially obscured to the same extent as illustrated in FIG. 5C.

FIG. 6E illustrates a user surfacing pane 630 with pointer icon 670, such as, for example, pointer icon 540 in FIG. 5, in order to reposition pane 630 on top of pane 640. In the context of these examples, surfacing means to surface or more a pointer icon over an individual pane through a user input, such as, for example, by manipulating a pointing device. The user surfaces the individual panes with the pointer icon for the purpose of placing the surfaced pane on top of any overlapping pane, thus making the surfaced pane fully visible. Alternatively, a user may reposition pane 630 on top of pane 640 by, for example, surfacing pane 630 with pointer icon 670 and then employing a mouse click. As shown above in FIG. 6D, pane 630 was partially obscured by pane 640 after pane 640 was resized. Now, as FIG. 6E illustrates, pane 630 is on top and fully visible, while pane 640 is underneath and partially obscured by pane 630, subsequent to the user surfacing pane 630 with pointer icon 670.

FIG. 6F shows a user further resizing pane 640 by moving the right border of pane 640 in a right lateral direction. Again, in partial adjacency constraint, panes 630, 640, and 660 remain the same size and in the same position. However, resizing pane 640 resizes or extends title bar 620. Title bar 620 is resized to accommodate the new size of pane 640 because pane 640 is adjacent and connected to title bar 620. This title bar resizing is in accordance with exemplary sizing behavior policy 3 stated above.

FIG. 6G depicts a user surfacing pane 660 with pointer icon 670 for the purpose of placing pane 660 on top of pane 640. After the user surfaces pane 660, or alternatively uses a mouse click, pane 660 is fully visible and pane 640 is partially obscured by pane 660. Panes 630 and 650 remain the same in the transition from FIG. 6F to FIG. 6G.

FIG. 6H illustrates a user resizing pane 660 by moving the left border in a right lateral direction. Thus, by resizing pane 660 in the above mentioned fashion, the width of pane 660 is reduced and consequently pane 640 is less obscured by pane 660. As shown, pane 660 and pane 630 are no longer in contact. This separation of adjacent panes is possible by using the default partial adjacency constraint setting. In addition, pane 650 may be resized in a right lateral direction to the same extent pane 660 is resized in a right lateral direction. This pane 650 resizing is in accordance with exemplary sizing behavior policy 1 stated above.

FIG. 6I once again shows a user resizing pane 660 from the FIG. 6G configuration. However, FIG. 6I illustrates a user resizing pane 660 from the FIG. 6G configuration in an optional full adjacency constraint setting, whereas FIG. 6H illustrates a user resizing pane 660 from the FIG. 6G configuration in the default partial adjacency constraint setting. Selecting or switching to the optional full adjacency constraint setting from the default partial adjacency constraint setting may be accomplished, for example, by using an alternate mouse click or a predetermined keystroke on a keyboard.

In FIG. 6I, common vertical border 680 moves as one unit in full adjacency constraint. Common vertical border 680 is common to panes 630, 640, and 660. Consequently, as common vertical border 680 moves in a right lateral direction, panes 630, 650, and 660 are accordingly resized. Thus, panes 630 and 650 increase in width as pane 660 decreases in width. In addition, pane 630 obscures more of pane 640 as pane 660 obscures less of pane 640. Further, panes 630 and 660 remain on top of pane 640 and are fully visible, while pane 650 remains underneath pane 660 and is partially obscured.

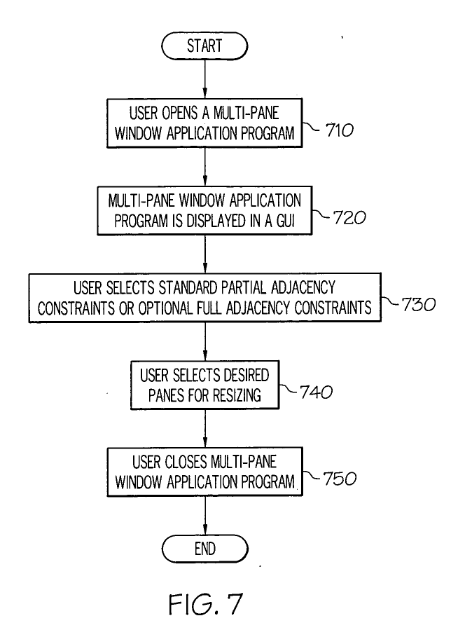

Turning now to FIG. 7, a flowchart is shown illustrating an exemplary process for resizing panes in partial and full adjacency constraints in a multi-pane window frame in accordance with an illustrative embodiment of the present invention. The process illustrated in FIG. 7 may be implemented in a computer, such as, for example, computer 100 in FIG. 1. More specifically, the process illustrated in FIG. 7 may be implemented in an operating system and/or an application program contained within computer 100 in FIG. 1, such as, for example, operating system 310 and/or application software 330 contained within data processing system 300 in FIG. 3.

The process begins when a user inputs a request, for example, via a mouse or keyboard, such as pointing device 360 or keyboard 370 in FIG. 3, to open a multi-pane window application program (step 710). The multi-pane window application program may be, for example, a program such as application software 330 in FIG. 3.

Subsequent to the multi-pane window application program opening in step 710, the multi-pane window application program displays a multi-pane window frame in a GUI, such as, for example, multi-pane window frame 510 is displayed in GUI 500 in FIG. 5 (step 720). The user views the multi-pane window frame in the GUI and inputs a desired pane configuration using, for example, the mouse (step 730).

Then, a determination is made as to whether the user selects an optional sizing constraint setting (step 740). If the user does not select the optional sizing constraint setting, no output of step 740, then the multi-pane window application program uses the default partial adjacency constraint setting to resize panes in the displayed multi-pane window frame (step 750). If the user selects the optional sizing constraint setting, yes output of step 740, then the multi-pane window application program uses the optional full adjacency constraint setting to resize panes in the displayed multi-pane window frame (step 760).

Subsequent to making the determination as to whether the user selects the optional sizing constraint setting in step 740, the multi-pane window application program resizes a pane in the displayed multi-pane window frame according to the sizing constraint setting in response to the pane configuration input by the user in step 730 (step 770). Then a determination is made as to whether the user input a request to close the multi-pane window application program (step 780). If the user does not input a request to close the multi-pane window application program, no output of step 780, then the process returns to step 730. If the user inputs a request to close the multi-pane window application program, yes output of step 780, then the multi-pane window application program closes in response to the user input (step 790) and the process terminates thereafter.

Thus, embodiments of the present invention provide a method, apparatus, and computer program product for managing panes in a multi-pane window frame. The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

What is claimed is:

1. A computer implemented method for managing panes in a multi-pane window frame, the computer implemented method comprising:
displaying the multi-pane window frame in a graphical user interface;
receiving a user pane configuration input;
identifying a sizing constraint setting, wherein the sizing constraint setting establishes adjacent pane interaction within the multi-pane window frame; and
resizing a pane contained within the multi-pane window frame based on the user pane configuration input and the sizing constraint setting.

2. The computer implemented method of claim 1, wherein the sizing constraint setting is at least one of a partial adjacency constraint and a full adjacency constraint.

3. The computer implemented method of claim 1, wherein resizing the pane is performed by a user using pane size handlers contained within pane borders of the multi-pane window frame.

4. The computer implemented method of claim 2, wherein the partial adjacency constraint setting provides independent pane resizing by a user.

5. The computer implemented method of claim 1, further comprising:
receiving a second user pane configuration input; and
repositioning a partially overlapped pane contained within the multi-pane window frame based on the second user pane configuration input, wherein repositioning the partially overlapped pane comprises positioning the partially overlapped pane on top of an overlapping adjacent pane.

6. The computer implemented method of claim 1, wherein the multi-pane window frame includes a title bar.

7. The computer implemented method of claim 6, wherein the title bar controls movement of the multi-pane window frame.

8. The computer implemented method of claim 1, wherein resizing the pane is governed by predetermined sizing behavior policies.

9. A data processing system for partial sizing adjacency constraints in a multi-pane window frame, comprising:
a bus system;
a storage device connected to the bus system, wherein the storage device includes computer usable program code; and
a processing unit connected to the bus system, wherein the processing unit executes the computer usable program code to display the multi-pane window frame in a graphical user interface; receive a user pane configuration input; identify a sizing constraint setting, wherein the sizing constraint setting establishes adjacent pane interaction within the multi-pane window frame; and resize a pane contained within the multi-pane window frame based on the user pane configuration input and the sizing constraint setting.

10. The data processing system of claim 9, wherein the sizing constraint setting is at least one of a partial adjacency constraint and a full adjacency constraint.

11. The data processing system of claim 9, wherein resizing the pane is performed by a user using pane size handlers contained within pane borders of the multi-pane window frame.

12. The data processing system of claim 10, wherein the partial adjacency constraint setting provides independent pane resizing by a user.

13. The data processing system of claim 9, further executes the computer usable program code to:
receive a second user pane configuration input; and
reposition a partially overlapped pane contained within the multi-pane window frame based on the second user pane configuration input, wherein repositioning the partially overlapped pane comprises positioning the partially overlapped pane on top of an overlapping adjacent pane.

14. The data processing system of claim 9, wherein resizing the pane is governed by predetermined sizing behavior policies.

15. A computer program product for partial sizing adjacency constraints in a multi-pane window frame, the computer program product comprising:
a computer readable medium having computer readable program code embodied therein, the computer readable medium comprising:
computer readable program code configured to display the multi-pane window frame in a graphical user interface;
computer readable program code configured to receive a user pane configuration input;
computer readable program code configured to identify a sizing constraint setting, wherein the sizing constraint setting establishes adjacent pane interaction within the multi-pane window frame; and
computer readable program code configured to resize a pane contained within the multi-pane window frame based on the user pane configuration input and the sizing constraint setting.

16. The computer program product of claim 15, wherein the sizing constraint setting is at least one of a partial adjacency constraint and a full adjacency constraint.

17. The computer program product of claim 15, wherein resizing the pane is performed by a user using pane size handlers contained within pane borders of the multi-pane window frame.

18. The computer program product of claim 16, wherein the partial adjacency constraint setting provides independent pane resizing by a user.

19. The computer program product of claim 15, further comprising:
computer readable program code configured to receive a second user pane configuration input; and
computer readable program code configured to reposition a partially overlapped pane contained within the multi-pane window frame based on the second user pane configuration input, wherein repositioning the partially overlapped pane comprises positioning the partially overlapped pane on top of an overlapping adjacent pane.

20. The computer program product of claim 15, wherein resizing the pane is governed by predetermined sizing behavior policies.
